(19) United States
(12) Patent Application Publication
(10) Pub. No.: US 2011/0214613 A1
(43) Pub. Date: Sep. 8, 2011

(54) Pet Water Drinking Bowl

(76) Inventor: Jerome Diamond, Henderson, NV (US)

(21) Appl. No.: 13/039,287

(22) Filed: Mar. 2, 2011

Related U.S. Application Data
(60) Provisional application No. 61/309,859, filed on Mar. 2, 2010.

(51) Int. Cl. A01K 7/00; A01K 29/00

(52) U.S. Cl. 119/61.55

(57) ABSTRACT

A lid for a pet water bowl having a lip which encircles the edge of the water bowl where the bowl has a centrally located opening located in the lid and a locking member located on the circumference of the lid. The top surface of the lid slopes downward from the lip of the lid to the centrally located opening and has a first flange which extends down from the bottom of the lid to engage the inside surface of the water bowl and a second flange which extending down from the bottom of the lid and converges toward the first flange to engage the edge of the lip of the water bowl.

### REFERENCE TO RELATED APPLICATIONS

This patent application claims the benefit of U.S. Provisional Application No. 61/309,859 filed on Mar. 2, 2010, the disclosure of which is incorporated herein by reference in its entirety.

### BACKGROUND OF THE INVENTION

1. Field of the Invention

The present invention relates generally to pet bowls and, more particularly to pet water bowls that help eliminate water that an animal scatters out of the bowl when lapping up water.

2. Description of Related Art

The prior art discloses many different types of bowls and containers that can be used to provide water for a pet animal. Often when a dog laps up water from a bowl which is on the floor, various amounts of water will be splashed out over the top of the bowl and fall on the floor. Different types of bowls and containers that are designed to reduce the amount of water that falls from a water bowl is known in the prior art. More specifically, by way of example, U.S. Pat. No. 7,306,112 to Shepard discloses an a spill-proof container that has a bowl with an access opening for holding particulate material that is freely rotatable within the chamber of a bowl support having an access opening. The access openings of the bowl and support are aligned when the bowl and support are both in their upright orientation. When the support is tipped, the bowl, which is heavier at its bottom, remains upright. As a result, the chamber access opening rotates out of alignment with the bowl access opening, which is then covered with a part of the chamber wall.

U.S. Pat. No. 7,017,518 to Zolnierz, et al., discloses attaching a guard device to a pet feeding bowl. The guard device is a bowl shaped guard that is positioned on top of a traditional pet feeding bowl. The guard device prevents food or water from being splashed out of the feeding bowl by the pet and has a diameter that is larger than that of the feeding bowl. As such, the guard device catches drippings from the animal that would not otherwise be caught by the feeding bowl.

U.S. Pat. No. 5,97,016 to Wesenhagen discloses a feeding dish having an apron section mounted on a bowl section. The apron section presents a reentrant overhang from the lip toward the center of the bowl to direct food coming up the inside the bowl back into the bowl.

U.S. Pat. No. 5,366,103 to Abernathy, et al., discloses a bowl having a larger diameter outer bowl, a smaller diameter inner bowl which is releasably and concentrically mounted inside the outer bowl, and an annular cover which is received around the top of the outer bowl. The inner bowl is for receiving food, and the central opening of the annular cover allows the user to remove the food from the inner bowl. If the bowl is abruptly moved to cause the liquid in the inner bowl to spill over the edge of the inner bowl, the liquid is deflected downwardly by the annular cover into the surrounding outer bowl.

U.S. Pat. No. 5,366,103 to Abulhasan discloses a divided food and water bowl centered and anchored on a flat rubber mat. The mat catches all spillages while the dog feeds or drinks.

US PreGrant Publication No. 2009/0241843 to Becattini, et. al., discloses a pet feeding system for food and water bowls having a base with one wall defining an interior space. The front section has a low portion and a high portion. The low portion provides a pet with access to the bowls, while the position of the high portion to the pet's head and shoulders prevents the pet from moving its head outside of the containment system while feeding to prevent spilling of food. Also disclosed is a filtering tray which is located above the base. The filtering tray has interstitial spaces that are sufficiently small to retain spilled food on the filtering tray but allow spilled water to pass through onto the base to allow a pet owner to collect and re-use spilled food.

US PreGrant Publication No. 2008/0072830 to Wrigge discloses two bowls having an annular moat there between to block ants. The first bowl has a first cylindrical lower portion with an outward flare before a first cylindrical upper portion. The second bowl has a second cylindrical lower portion that receives the first bowl. The second bowl has a larger second cylindrical upper portion that provides an annular space between the second bowl and the first bowl. The annular space is filled with a liquid to keep ants from getting to the food or water inside of the first bowl

### SUMMARY OF THE INVENTION

In an exemplary embodiment of the present invention, there is disclosed a lid for a pet water bowl having a lip which encircles the edge of the water bowl comprising:

a centrally located opening located in the lid;

a locking member located on the circumference of the lid;

the top surface of the lid is concave sloping downward from the lip of the lid to the centrally located opening;

a first flange extending down from the bottom of the lid to engage the inside surface of the water bowl; and

a second flange extending down from the bottom of the lid positioned to engage the edge of the lip of the water bowl;

wherein the second flange converges toward the first

flange.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of a pet water bowl with snap on lid in accordance with the principles of the invention;

FIG. 2 is a top view of the snap on lid of the pet water bowl in accordance with the principles of the invention;

FIG. 3 is a sectional view of the pet water bowl along the line 3-3 of FIG. 1 where the lid has been removed;

FIG. 4 is a sectional view of the pet water bowl along the line 3-3 of FIG. 1 where the lid is attached to the bowl;

FIG. 5 is an enlarged detail view “B” of the lip of the cover located on the lip of the pet water bowl; and

FIG. 6 is an enlarged detail sectional view of the edge of the cover located on the pet water bowl of an embodiment of the invention;

### DESCRIPTION OF THE PREFERRED EMBODIMENT

Animals drinking from a typical open top water bowl normally get their face, ears and the floor around the water bowl wet. The pet will normally drop, splatter or spill water on the floor around their water bowl. In each instance, the dropped water is unsightly, can attract bugs and rodents, and cause the growth of mold and mildew and possibly allergies and health issues if not constantly cleaned up. In addition, dropped or spilled water on the floor may be tracked through a house by a pet as he steps in the spilled or splattered water and walks away from the water bowl. Thus, a pet owner can end up cleaning not only around a pet's water bowl but, in addition, water that is tracked thru the house.

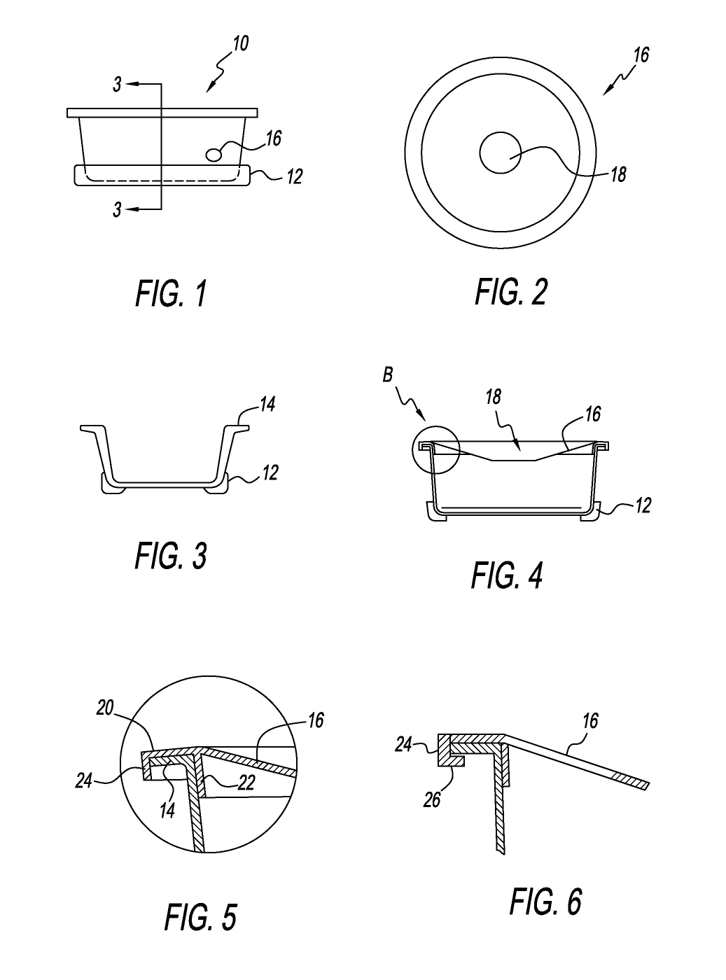

Referring to FIG. 1, there is shown a side view of a pet water bowl 10 with a snap on lid which has a water access opening in accordance with the principles of the invention. The water bowl may be made of a rigid or semi-rigid plastic which is water impermeable or of stainless steel. The bowl may have a height of about 63.0 mm, more or less, a diameter of about 145.0 mm more or less and is sized to hold about one quart of water. To help prevent the water bowl from being pushed by the pet as he/she is drinking water, specifically when the bowl is on a wood or tile floor, a band of rubber 12 which has an L shaped cross section (see FIG. 3) is attached to the bottom edge of the bowl where each leg of the L shaped cross section may be between one half of an inch and one inch, more or less. The band of rubber may have a diameter that is slightly less than the diameter of the bottom edge of the bowl and is stretched when located on the bowl to form a snug fit.

The bowl has a lid that extends substantially horizontally out from the top of the bowl to form a lip 14 which has a length of about 10 mm more or less, see FIG. 5, and a downward slope of between zero degrees and ten degrees, where a downward slope of five degrees is preferable. At least one finger grip 16 for receiving a person's finger may provided for carrying the bowl where the finger grip may be an indentation that is located above the band of rubber 12 and which extends into the bowl for a distance of between one quarter of an inch and five eighths of an inch, where an indentation of about three eighths of an inch is preferable. The diameter of the finger grip is sufficient to receive a person's thumb or middle finger where the other fingers a user's hand are at the top or bottom of the bowl.

Referring to FIG. 2, there is shown is a top view of the snap on lid 16 of the water bowl in accordance with the principles of the invention. The lid is disk shaped and includes a centrally located opening 18 and a locking member 20 located around its circumferential. Looking at FIG. 5, there is shown an enlarged detail view “B” of the locking member 20 on the circumference of the lid engaging the flange 14 on the bowl. The locking member includes a channel formed by two downwardly extending flanges 22, 24 where the width of the channel between the flanges is substantially equal to the width of the lip 14 on the bowl. Flange 22 which is adapted to engage the inside surface of the bowl has a length of about 10 mm, more or less, and flange 24 which is adapted to engage the edge of lip 14 has a length of about 6.5 mm, more or less. Flange 24 converges toward flange 24 at an angle of about five degrees, more or less.

Looking now at FIG. 4, the lid 16 is concave with a pitch of between ten degrees and twenty degrees, more or less toward the center opening 18 where a pitch of about fifteen degrees is preferable. The centrally located opening 18 in the lid may have a diameter of about thirty six mm, more or less, which permits the tongue of a small dog or pet to get to the water in the bowl without letting the animals face, ears, or feet getting to the water. Any excess water that falls on or splashes up onto the concave surface of the lid will roll down the concave surface of the lid and fall back into the bowl via the opening 18. With restricted access to the water in the bowl, the floor around the bowl stays drier than with a water bowl that has no lid with a centrally located opening. The lid 14 may be made of a plastic such as melamine or the like and may be of a clear plastic which allows the pet owner to see how much water is in the bowl. In use, after the bowl is cleaned and filled with water, the lid is placed on top of the bowl and downward pressure is applied to the top edge of the lid until the lid snaps onto the lip of the bowl.

Referring to FIG. 6, there is shown an enlarged sectional view of an embodiment of the invention where the edge of the lid has a hook which engages the edge of the lip of the bowl. In the embodiment shown in FIG. 6, the end 26 of downward extending flange 24 extends substantially horizontally toward the bowl to form a hook which is adapted to engage the end of the bowl lip. In use, after the bowl is cleaned and filled with water, the lid is placed on top of the bowl and the end 26 of the lid is bent up by pulling up on the end of the lid until the edge of the bowl lip snaps into the hook in the edge of the lid.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A lid for a pet water bowl having a lip which encircles the edge of the water bowl comprising:
a centrally located opening located in the lid;
a locking member located on the circumference of the lid;
the top surface of the lid is concave sloping downward from the lip of the lid to the centrally located opening;
a first flange extending down from the bottom of the lid to engage the inside surface of the water bowl; and
a second flange extending down from the bottom of the lid positioned to engage the edge of the lip of the water bowl;
wherein the second flange converges toward the first flange.

2. The lid of claim 1 wherein the first flange is longer than the first flange.

3. The lid of claim 2 wherein the space between the first and second flange forms a channel having a width that is substantially equal to the width of the lip on the bowl.

4. The lid of claim 3 wherein the second flange converges toward the first flange at an angle of about five degrees.

5. The lid of claim 4 wherein centrally located opening in the lid has a diameter of about thirty six mm.

6. The lid of claim 5 wherein the lid is made of a plastic.

7. The lid of claim 6 wherein the plastic lid is transparent.

8. The lid of claim 7 wherein the lid is made of melamine

9. The lid of claim 4 wherein the top surface of the lid slopes downward from the lip of the lid to the centrally located opening at an angle of between ten degrees and twenty degrees.

10. The lid of claim 9 wherein the lid slopes down at an angle of about fifteen degrees.

11. The apparatus of claim 1 wherein a band of rubber encircles the bottom edge of the bowl to prevent the water bowl from being pushed by a pet as he is drinking water.

12. The apparatus of claim 11 wherein the band of rubber has an L shaped cross section.

13. The apparatus of claim 1 wherein the water bowl is made of a water impermeable plastic.

14. The apparatus of claim 13 wherein the plastic water bowl has a finger grip for carrying the water bowl.

15. The apparatus of claim 14 wherein the finger grip is an indentation in the side of the bowl.
